(19) United States
(12) Patent Application Publication
(10) Pub. No.: US 2024/0356686 A1
(43) Pub. Date: Oct. 24, 2024

(54) An Automation Network With Actively Managed Redundant Connectivity

(71) Applicant: ABB Schweiz AG, Baden (CH)

(72) Inventors: Zhibo Pang, Västerås (SE); Pawel Wiatr, Upplands Väsby (SE); Ognjen Dobrijevic, Västerås (SE); Jörgen Gade, Västerås (SE)

(21) Appl. No.: 18/687,644

(22) PCT Filed: Sep. 6, 2021
(86) PCT No.: PCT/EP2021/074437

§ 371 Date: Feb. 28, 2024

(51) Int. Cl. H04L 1/22; G05B 19/418; H04L 43/0829; H04L 43/087; H04L 43/0888

(52) U.S. Cl. CPC H04L 1/22; H04L 43/0829; H04L 43/087; H04L 43/0888; G05B 19/41855

(57) ABSTRACT

A control network for supporting multiple industrial automation devices which operate in radio coverage of at least one radio access network includes: a processor configured to execute applications; at least two wireless network interfaces, each configured to communicate with the automation devices; and a traffic controller configured to provide a logical connection from an executing application to one of the automation devices by maintaining at least two contemporaneous physical connections using respective wireless network interfaces and the radio access network. The control network is further configured to repeatedly adapt a physical redundancy of the logical connection. In some embodiments, the control network is configured to determine a level of independence between the physical connections on the basis of measurements, and adapt the redundancy accordingly. The level of independence may be determined by comparing time series of a quality-of-service related quantity.

### TECHNICAL FIELD

The present disclosure relates to the field of industrial automation. In particular, it proposes methods and devices for managing redundant connectivity in a control network adapted for supporting multiple industrial automation devices.

### BACKGROUND

Low-latency and high-reliability wireless communication will be a crucial enabler of the onward evolution of mobile robotics and many other industrial applications. Despite large efforts already made within the emerging wireless technologies, such as the 3GPP NR (5G) and newer Wi-Fi™ standards, the latency and reliability still need to be improved, especially when high availability and safety are required. The use of redundant wireless links between a controlling and a controlled entity is expected to be an effective approach for improving communication reliability and reducing latency. The redundancy may be achieved by the use of two or more contemporaneous physical connections to provide a common logical connection between the entities.

To mention a few examples, U.S. Pat. No. 20,200,187286 discloses a system comprising a robot controller and a robot. Rather than coordinating the operation of multiple robots, this robot controller is in a one-to-one relationship with a particular robot. The robot and the robot controller are associated with connectivity components for enabling multiple concurrent wireless links between the robot and the robot controller for providing reliable communication. The links are related to different communications networks, such as 3GPP LTE or NR and Wi-Fi™. The statuses of the networks are monitored and the degree of sensitivity of the robot operation to a transmission failure between the robot and the robot controller is estimated. Based on this information, it is determined whether single or multiple links should be used for the communication and which wireless interface(s) should be used.

U.S. Pat. No. 20,080,250162 discloses a process control system, comprising a controller and field devices. The wireless communication paths established to communicatively couple each of the field devices to the controller are automatically determined within the system. The field device can communicate with the controller via two or more different paths, implemented using different communication protocols. The communication paths are selected to provide the highest transmission and signal quality. It is the field devices that measure and determine the appropriate communication paths.

U.S. Pat. No. 20,170,285622 discloses a system for monitoring and controlling operational assets, e.g. an industrial sensor or operation equipment. A backend system sends control instructions to the assets and gathers data from the assets via a network edge device. The network edge device comprises a radio-frequency (RF) protocol module with multiple RF modules, and it can communicate with the backend system through multiple RF networks concurrently.

If challenging application-specific cost limits are to be met, redundancy should be applied with moderation and where it is certain to add value. The available technologies leave room for improvement in both quantitative and qualitative terms: when should redundancy be activated? how much redundancy is justified? by what means shall the redundancy be achieved?

### SUMMARY

One objective of the present disclosure is to make available a control network in which the logical connection between a control application and an automation device is adapted in view of operating conditions as these change. It is another objective to perform this adaptation on the basis of quantities which do not require the provision of new sensing modalities but are observable in a largely unmodified control network according to the state of the art. Another objective of the present disclosure is to make available a traffic controller and a method for use with such control network.

At least some of these objectives are achieved by the invention as defined by the independent claims. The dependent claims relate to advantageous embodiments of the invention.

In a first aspect of the present invention, there is provided a control network for supporting multiple industrial automation devices which operate in radio coverage of at least one radio access network. The control network includes a processor, at least two wireless network interfaces and a traffic controller. The processor is configured to execute one or more software applications. Each of the wireless network interfaces is configured to communicate with said automation devices. The traffic controller is configured to provide a logical connection from an executing software application to one of the automation devices by maintaining at least two contemporaneous physical connections to said one of the automation devices using respective wireless network interfaces and said at least one radio access network. The control network is further configured to repeatedly adapt a physical redundancy of the logical connection.

Because the control network adapts the physical redundancy of the logical connection repeatedly, it is possible to ensure at each point in time that a suitable level of redundancy is applied. The level of redundancy can be quantified as the number of physical connections to be maintained in order to provide the logical connection. By the repeated adaptation of the physical redundancy, it can furthermore be ensured that the means for achieving the redundancy are the most appropriate ones. For example, if it is found that the respective performance patterns of the two physical connections are strongly correlated in time, they are likely to fail simultaneously and thereby effectively do not make a significant addition to the reliability of the logical connection.

In the present disclosure, the act of repeatedly adapting the physical redundancy may be a repeated point-wise event or it may be a continuous process. A point-wise adaptation event may include obtaining an up-to-date value of an observed quantity, evaluating this against a predefined control law or criterion, and ascertaining whether the physical redundancy in force can be left unchanged or needs to be adjusted. The redundancy adaptation event may be repeated periodically or in response to detecting a predefined event; the predefined event may relate to the status of a network or to the operation of the automation devices. The smaller the repetition period is set, the more the repeated adaptation approaches a quasi-continuous process. Within the scope of the invention, repeatedly adapting the physical redundancy may include detecting variations in the observed quantity and configuring the processor such that the detected variation triggers an evaluation of the new value of the observed quantity. In some embodiments, the mentioned adjustment of the physical redundancy is governed by the processor which feeds configuration data to the traffic controller, which causes the traffic controller to modify control parameters relating to the physical connections that it maintains, to add/remove a physical connection or take other actions.

In some embodiments, the control network is configured to determine a level of independence between the contemporaneous physical connections on the basis of measurements, and to adapt the physical redundancy accordingly. According to a preferred task division, the processor determines the level of independence and orders the traffic controller to adapt the physical redundancy. This task division, where the novel independence assessment is localized to the processor, makes it possible to deploy non-specialized or unsophisticated hardware as traffic controller. The preferred task division further avoids the need to grant the traffic controller access to the measurements, which could compromise data security unnecessarily.

In some embodiments, to determine the level of independence, the control network may monitor a time series of quality of service (QOS), latency, reliability, throughput, jitter and/or rate of packet loss for (some or all of) the respective contemporaneous physical connections, and determine the level of independence of these connections by comparing the respective time series. This comparison constitutes an indirect evaluation process which enables the control network to judge the redundancy resulting from the physical connections in use. The evaluation process is indirect in the sense that it can be completed without knowledge of or insights into the network infrastructure that supports the physical connections, e.g., the presence of shared entities that could become single points of failure or weaknesses at the level of the network topology. Another benefit of the evaluation process is that it targets the effective (or delivered) redundancy; indeed, even in situations where the constitution of a network infrastructure is known in detail, significant expertise may be required to correctly predict how the infrastructure will behave under unusual loads or outages. The fact that this evaluation process uses performance-oriented quantities such as QoS is a still further benefit; quantities of this type can be perceived from the viewpoint of an ordinary user, and they can often be sensed without a pressing need for sophisticated or invasive measuring equipment.

In a second aspect of the invention, there is provided a traffic controller for use in a control network supporting multiple industrial automation devices which operate in radio coverage of at least one radio access network. The traffic controller has at its disposal at least two wireless network interfaces. It is configured to provide a logical connection from a software application, which executes in the control network, to one of the automation devices. It does so by maintaining at least two contemporaneous physical connections to said one of the automation devices using the wireless network interfaces.

In a third aspect, there is provided a method of establishing a logical connection with physical redundancy between a control network and an industrial automation device, which operate in radio coverage of at least one radio access network. The method comprises: establishing at least two physical connections between the control network and the automation device; establishing the logical connection using a higher-layer communication protocol; and repeatedly adapting a physical redundancy of the logical connection.

The second and third aspects of the invention generally share the advantages of the first aspect and may achieve similar results. They can be implemented with a corresponding degree of technical freedom.

The invention further relates to a computer program containing instructions for causing a computer, or the control network in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical, or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.,” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 is a block diagram representing a control network and a plurality of automation devices;

FIGS. 2 and 3 show, according to two embodiments, some functional components that support traffic splitting and merging in the control network and one of the automation devices;

FIG. 4 illustrates three physical connections which provide one logical connection between the control network and one of the automation devices, wherein the physical connections are supported by two radio access networks;

FIG. 5 contains two plots where quality-of-service time series are plotted for respective pairs of physical connections; and

FIG. 6 is a flowchart of a method for establishing a logical connection with physical redundancy.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

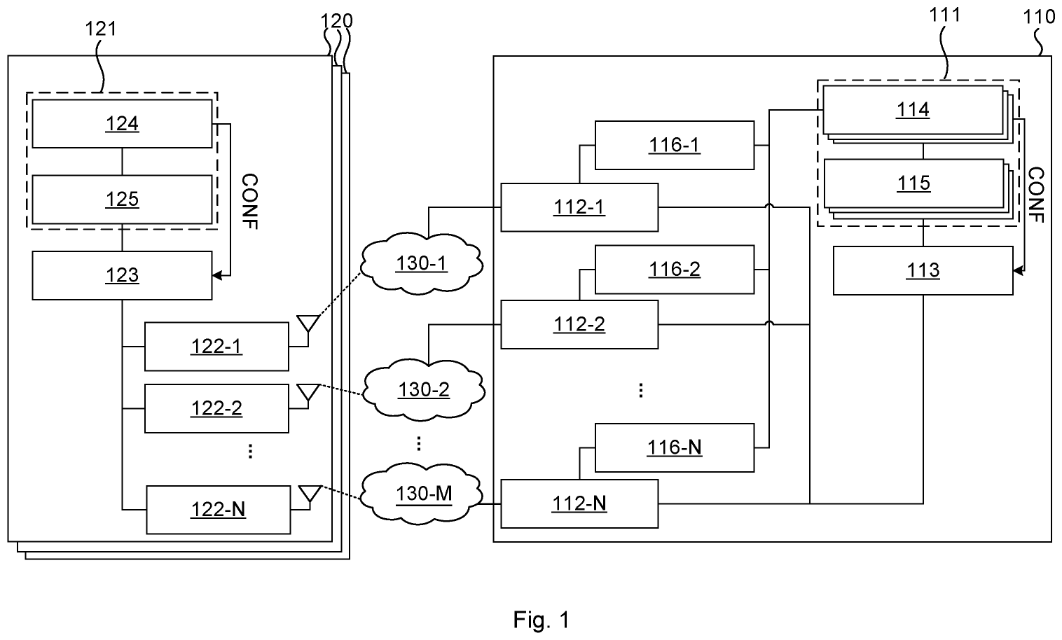

FIG. 1 illustrates, in block-diagram form, a control network 110 and a plurality of industrial automation devices 120. Components of one automation device 120 are indicated in FIG. 1, with an understanding that the further automation devices 120 have a corresponding structure. In the context of the present disclosure, an industrial automation device 120 may be, for example, a stationary robot, a mobile robot, fences, light curtains, cameras, motors, conveyor belts.

The control network 110 includes a processor 111 configured to execute software applications 114, including control applications for controlling the automation devices 120. The processor 111 may further be configured to execute one or more automation network stacks 115. As used herein, an automation network stack 115 may include protocols for controlling different levels of the operation of the automation devices 120.

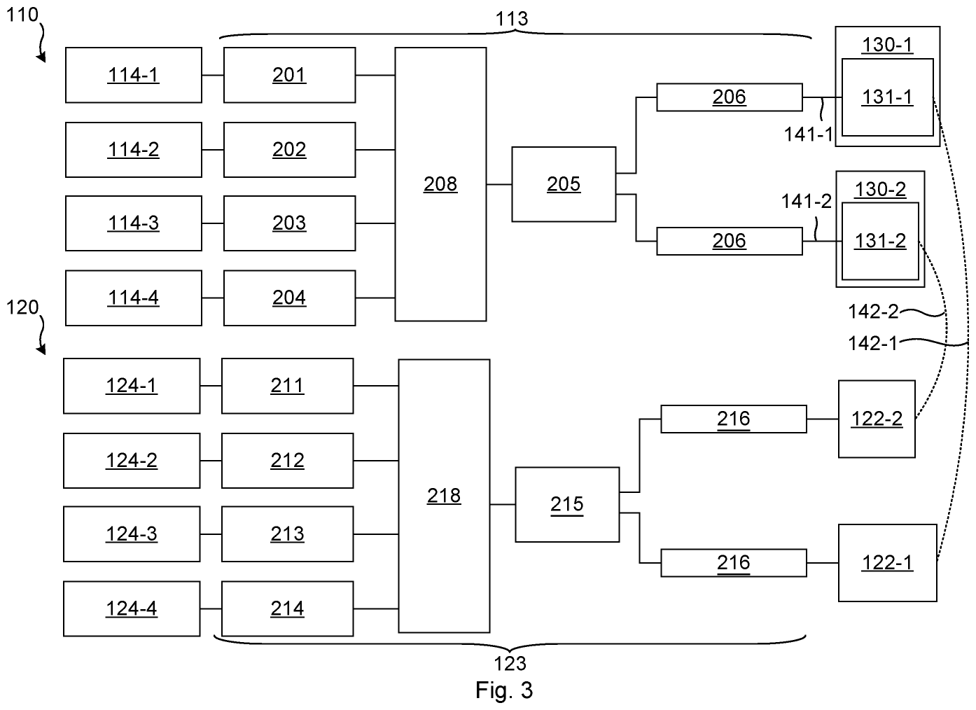

For purposes of communicating with the automation devices 120, the control network 110 is further equipped with N≥2 wireless network interfaces 112-1, 112-2, . . . , 112-N. Each wireless network interface 112 is connected, by a wired or wireless link, to a radio access network 130-1, 130-2, . . . , 130-M. It is noted that the radio access networks 130 may be as many as the network interfaces 112 (M=N). Alternatively, and notably since the network interfaces 112 are not necessarily active simultaneously and/or the use of different cells within a cellular access network can achieve the desired redundancy, the radio access networks 130 may be fewer than the network interfaces (M<N, like in FIG. 4). In some embodiments, the control network 110 connects to an automation device 120 over a single radio access network 130 (M=1).

The network interfaces 112 are controlled and coordinated by a traffic controller 113. The traffic controller 113 may operate in accordance with instructions encoded in configuration data CONF, which it receives or retrieves from the processor 111. The processor 111 may be configured to define a setpoint redundancy level for each executing application 114, determine the configuration data CONF in accordance with the setpoint redundancy level, and feed the configuration data to the traffic controller 113. The setpoint redundancy level may be defined in view of the importance or criticality of each executing application 114, wherein e.g. a safety-related application could be assigned a higher redundancy level than a non-safety-related application. The configuration data CONF may consist simply of the setpoint redundancy level or may contain additional implicit or explicit requirements, which the traffic controller 113 shall achieve by determining or adjusting a routing plan.

The radio access networks 130 are heterogeneous in the sense that they may belong to different telecommunication technologies, such as cellular and non-cellular. Further, the dependencies among the radio access networks 130 are minimized by working on different frequency bands or with different antenna array settings (spatial diversity), by being operated by different operators, by sharing no (or a minimum of) hardware infrastructure, etc. Feasible options of the heterogeneous radio access networks include, but are not limited to: 3G/UMTS, 4G/LTE, 5G/NR, 6G, WiFi3, WiFi4, WiFi5, WiFi6/6E, WiFi7, satellite broadband, visible light communication (VLC or Li-Fi), ultra-wide band (UWB), etc.

The control network 110 further comprises N network supervisors 116-1, 116-2, . . . , 116-N, whose functioning will be described in a later section. In the depicted embodiment, the network supervisors 116-1, 116-2, . . . , 116-N are in a one-to-one relationship with the wireless network interfaces 112-1, 112-2, . . . , 112-N.

It is noted that the control network 110 may be implemented as a localized physical unit, or it may be an arrangement of spatially distributed connected components. The control network 110 may act as an automation backbone in an industrial site or a group of industrial sites.

Turning to the left-hand side of FIG. 1, it is seen that the illustrated one of the automation devices 120 includes a processor 121, which is configured for executing automation device applications 124 and/or an automation network stack 125, a plurality of wireless network interfaces 122-1, 122-2, . . . , 122-N, and a traffic controller 123. It is noted that the wireless network interfaces 122 have been drawn with wireless links to the radio access networks 130, although wired links would have been imaginable as well in the exceptional case of a stationary automation device 120. Generally speaking, the functionalities of the components 121, 122, 123 are analogous or complementary to those of components 111, 112, 113 in the control network 110 and will not be repeated here. While the automation device 120 has the same number of wireless network interfaces 122 as the control network 100 in the illustrated example, this is not an essential feature of the present invention. Compared with the traffic controller 123 in the automation device 120, the traffic controller 113 in the control network 110 may have more extensive responsibilities and powers, which include decision-making regarding the current physical redundancy of the logical connection between the executing software applications 114 and the automation devices 120 (or the execution of such decisions).

The physical and logical links provided by the traffic controllers 113, 123 will now be discussed with reference to FIG. 4. The figure shows one logical connection 143 extending between, on the one hand, a control application 114 executing on the processor 111 of the control network 110 and, on the other hand, an automation device application 124 executing on the processor 121 of the automation device 120. The logical connection 143 may be understood as a representation of the communication services offered by multiple contemporaneous physical connections 140-1, 140-2, 140-3 which the traffic controllers 113, 123 maintain with the aid of the respective wireless network interfaces 112-1, 112-2, 112-3, 122-1, 122-2, 122-3. From the point of view of the executing applications 114, 124, the logical connection 143 may be characterized as an abstract representation since the applications need not be aware of the number or nature of the physical connections 140-1, 140-2, 140-3. This is to say, the physical paths on which the data exchanged by the applications 114, 124 is routed is an unimportant factor which is hidden from the applications 114, 124.

Still referring to FIG. 4, each physical connection 140 includes a control-network-side link 141 between one of the control network's 110 wireless interfaces 112 to a radio access network 130 and an automation-device-side link 142 between the radio access network 130 and one of the automation device's 120 wireless interfaces 122. Each of the links 141, 142 may be wired or wireless. It is understood that the physical connection 140 may include a segment which passes through the infrastructure of the radio access network 130, including one or more access points (APs) or radio base stations and/or core-network components. If a wired link 141, 142 is used on either side, its connection point may be in the core network (network backbone), from which the data to be transmitted travels to the associated radio access network 130. Especially, the wireless interfaces 112 of the control network 110 may be connected to one or more of the radio access networks 130 through a wired link (e.g., backbone interface) rather than over a wireless link. The use of a wired link may reduce the latency of the link 141 and improve its reliability. The wired backbone interface can include (commercial) Ethernet, Time-Sensitive Networking (TSN, see for instance IEEE 802.1Q), an optical network, or the like.

FIG. 4 illustrates that it is possible within the scope of the present invention for two or more pairs of wireless network interfaces 112-2, 122-2 and 112-3, 122-3 to use a common radio access network 130-2. In a possible implementation, the common radio access network 130-2 is a cellular network, and the contemporaneous physical connections 140-2, 140-3 may use different cells of the network 130-2. It is recalled that many cellular network standards allow a single base station (e.g., eNB in 3GPP LTE) to serve multiple cells, whereby independently operating cells can be defined that cover nearby-or even overlapping-regions of space. In practice, cells defined in this way may be sufficiently dense to support two or more independent physical radio links to one automation device 120. The common base station serving the multiple cells is certainly a potential single point of failure in case of a hardware outage. Yet since the base station will be executing an independent instance of the base-station software (e.g., scheduling) for each of the cells, a runtime failure affecting one cell will not propagate to the other cells in normal circumstances. Accordingly, the logical connection 143 will remain operable.

As FIG. 4 also illustrates, different physical connections 140-1, 140-2 can use different radio access networks 130-1, 130-2. Two different radio access networks can be completely overlapping in space, which allows an automation device 120 at a given position to be in excellent radio coverage of both.

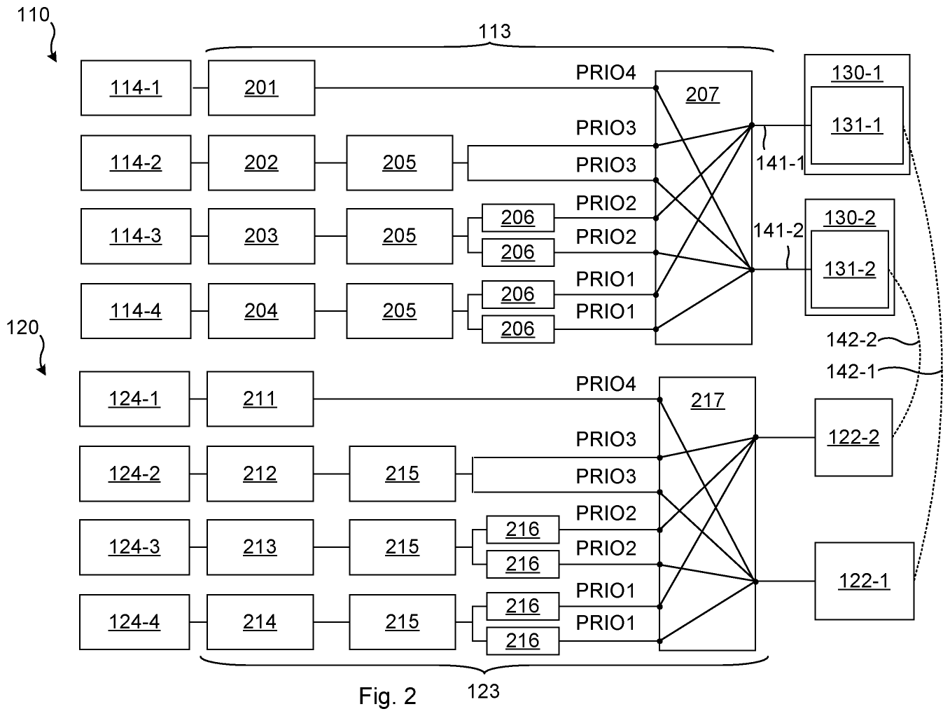

The control network 110 repeatedly adapts the physical redundancy of the logical connection 143. In some embodiments, it is incumbent on the processor 111 in the control network 110 to repeatedly adapt the physical redundancy of the logical connection 143. Results of the decision-making relating to the physical redundancy adaptations can be conveyed to the traffic controller 113. For example, the processor 110 can update, as often as necessary, the configuration CONF. Analogous or complementary operations may be performed by the automation device's 120 processor 121 and traffic controller 123. It is clear from the above discussion that the current number and chosen types of the physical connections 140 that make up the logical connection 143 constitute variable factors that contribute to the level of physical redundancy. FIGS. 2 and 3 show possible inner workings of the traffic controllers 113, 123, and will illustrate some aspects of their operation that are open to configuration.

FIG. 2 relates to an embodiment where the traffic controllers 113, 123 are implemented by a combination of Frame Replication and Elimination for Reliability (FRER, see IEEE 802.1CB), IP tunneling, and a Time-Sensitive Networking (TSN) switch. This embodiment is suitable, for example, when the automation device 120 is a mobile robot. For instance, the traffic controller 113 in the control network 110 may be a non-specialized network switch with an FRER capability. Cellular (UMTS, LTE, 5G) and Wi-Fi™ (WiFi4/5/6/6E) networks are deployed as the heterogeneous wireless networks 130-1, 130-2. Various applications produce the traffic based on different protocols, such as the Message Queuing Telemetry Transport (MQTT) for the remote services over Microsoft Azure™, ABB Ability™ or the like; Data Distribution Service (DDS) for the interaction among applications developed on the Robot Operating System, version 2 (ROS2); PROFINET™ for integration with external process controllers such as the programmable logic controller (PLC); PROFIsafe™ (over PROFINET™) for integration with external safety controllers. To increase the reliability and reduce latency, the DDS, PROFINET™ and PROFIsafe™ traffic is processed by IEEE 802.1CB FRER, while the MQTT traffic is not since it is not time-critical. The replicated traffic flows of PROFINET™ and PROFIsafe™ are encapsulated in Internet Protocol (IP) packets so that they can be transmitted seamlessly over 3GPP cellular networks. It is recalled that IP packet transmission is supported by the most recent releases of 3GPP UMTS, LTE and NR, and by a significant number of earlier releases. All the traffic flows are finally switched by a TSN switch according to the assigned priorities.

The upper half of FIG. 2 shows components of the control network 110 and the lower half shows components of an automation device 120. The drawn components do not necessarily correspond to physical components but may also symbolize, for example, instances of executing software, network functionalities, abstract representations of a physical component, a group of physical components, or a sub-aspect of a physical component. The links between the drawn components symbolize traffic flows; the actual connectivity within the control network 110 and automation device 120 may have a more extensive topology. The automation device 120 is connected to the control network 110 by two physical connections made up of links 141, 142 shown in the right-hand part of the figure. A situation is considered where a number of control applications 114 execute on the control network's 110 processor 111 and corresponding applications 124 execute on the automation device's 120 processor 121. The applications include: Remote Service applications 114-1, 124-1, Navigation applications 114-2, 124-2, Process Control applications 114-3, 124-3, and Safety applications 114-4, 124-4.

As suggested by the four individual traffic flows, each of the control applications 114 is able to exchange data with the traffic controller 113 independently of the other control applications 114. In some embodiments, like the one illustrated in FIG. 2, the traffic controller 113 may also include different entry points for the different control applications 114. For example, the Remote Service application 114-1 may interface with a message server, such as a MQTT Broker instance 201. The Navigation application 114-2 may interface with a publish-subscribe instance, such as Data Distribution Service (DDS) Publisher and Subscriber instance 202. The Process Control application 114-3 may interface with a protocol entity of a communication protocol adapted for industrial control, such as a PROFINET™ Master instance 203. The Safety application 114-4 may interface with a protocol entity of a communication protocol adapted for industrial safety, such as a PROFIsafe™ F-Host instance 204. The traffic controller 123 in the automation device 120 may have a similar constitution as far as the data exchange with the automation device applications 124 is concerned. The entry-point components 211, 212, 213, 214 therein may be analogous or complementary to the entry-point components 201, 202, 203, 204 in the control network's 110 traffic controller 113. In one embodiment, these are an MQTT Client instance 211, a DDS Publisher and Subscriber instance 212, a PROFINET™ Slave instance 213 and a PROFIsafe™ F-Device instance 214, respectively.

Downstream of the entry-point components 201, 202, 203, 204 in the control network's 110 traffic controller 113, the already mentioned FRER 205 is applied to the traffic flows originating from the Navigation, Process-Control and Safety applications 114-2, 114-3, 114-4. The IP encapsulation of the traffic flows originating from the Process-Control and Safety applications 114-3, 114-4 is effectuated by two parallel IP tunneling endpoints 206. The TSN switch 207 at the rightmost end of the traffic controller 113 switches all the traffic flows in accordance with the assigned priorities PRIO1, PRIO2, PRIO3, PRIO4, wherein a smaller number represents a higher priority. In the automation device's 120 traffic controller 123, an inverse processing chain is found, that is, the TSN switch 217 and IP tunneling endpoints 216 are followed by FRER 215 and then the entry-point components 211, 212, 213, 214. It is recalled that the traffic flows are bidirectional, so that, for example, each one of the FRERs 205, 215 is adapted to perform both replication on outbound traffic and elimination of frames on inbound traffic, as needed.

The two physical connections between the control network 110 and automation device 120 are composed of wired connections 141-1, 141-2 from respective wireless network interfaces 112 (see FIG. 1 or 4) directly to points in the core networks (backbones) of the radio access networks 130-1, 130-2. The first physical connection is further composed of a wireless connection 142-1 from a cellular base station (NB, eNB, gNB) 131-1 of the cellular network 130-1 to a user equipment device 122-1 in the automation device 120. The second physical connection is further composed of a wireless connection 142-2 from a Wi-Fi™ access point 131-2 to a WiFi™ client 122-2 in the automation device 120.

FIG. 3 shows a variation of the embodiment of FIG. 2, where the traffic splitting and merging is organized differently. Here, switches 208, 218 with quality-of-service (QOS) management are arranged immediately downstream of (i.e., one step further away from the applications 114) the entry-point components 201, 202, 203, 204, 211, 212, 213, 214. Each switch 208, 218 accepts the multiple (e.g., four) bidirectional traffic flows from the entry-point components 201, 202, 203, 204, 211, 212, 213, 214 on its upstream side and provides a single bidirectional traffic flow on its downstream side. The single traffic flow is passed to FRER 205, 215, where it is replicated into as many traffic flows as there are physical connections, and each such traffic flow undergoes IP encapsulation in IP tunneling endpoints 206, 216. The two physical connections between the control network 110 and automation device 120 are configured similarly to the embodiment shown in FIG. 2.

To summarize the embodiments shown in FIGS. 2 and 3, the traffic controllers 113, 123 may have one or more of the following capabilities:
replicate a single traffic flow from the source into multiple redundant traffic flows by, e.g., duplicating every packet into multiple copies with distinguish-able identifiers;
eliminate the received redundant traffic flows into a single traffic flow to the destination, e.g. if any of the multiple copies is received correctly, discard the copies that arrive later;
assign proper priorities PRIO1, PRIO2, . . . to the traffic flows; these assignments may be in accordance with a classification of the flows into categories such as isochronous, synchronous cyclic, asynchronous cyclic, events, video (see Integration of 5G with Time-Sensitive Networking for Industrial Communications, white paper, 5G-ACIA, 2021);
translate (transcode) between the protocols supported by the automation network stacks 115, 125 and the protocols supported by the radio access networks 130; and.
switch, route, schedule, and buffer the traffic flows between the automation network stacks 115, 125 and the wireless radio access network interfaces 112, 122 according to the assigned priorities.

In respect of the two first items, it is noted that frame replication and elimination (e.g., by FRER) is preferably applied to such traffic flows which include the data with the highest priority but may be omitted for other traffic flows. The traffic flows which include the data with the highest priority may be obtained directly from the concerned executing applications 114, 124 or their respective entry-point components 201, 202, 203, 204, 211, 212, 213, 214, like in FIG. 2. Alternatively, these traffic flows may have been prepared by a switching process where such traffic flows are multiplexed with less prioritized traffic flows, like in FIG. 3. Similarly, IP encapsulation (IP tunneling) is preferably applied to the traffic flows where the most prioritized data travels. The traffic controller 113 may further include an ability to identify traffic flows (or streams), e.g., using stream identification methods following in the IEEE 802.1CBdb standard.

These activities in the control network's 110 traffic controller 113 as well as the repeated redundancy adaptations to be carried out by the traffic controller 113 may be supported by the network supervisors 116. Each of the network supervisors 116 may be configured to perform one or more of the following:
configure, onboard, manage and remove the automation devices 120 connected to the respective radio access network 130, including security management;
monitor the status of the respective radio access network 130 and notify the control application 114 properly (e.g. network alarm) if there is network outage or performance degradation;
request resources, e.g. bandwidth, and priorities PRIO1, PRIO2, . . . for the traffic flows and the devices, from the radio access networks 130;
steer the configuration of the radio access networks 130, at least partially on the basis of “static” information; for example, the steering may aim to avoid combinations of radio access networks 130 that potentially share same infrastructure and/or same frequency spectrum, and this may be achieved by imposing suitable restrictions;
measure the actual level of independence of the radio access networks 130, e.g., by monitoring the temporal pattern of the quality of the service (QOS) including latency, reliability, jitter, packet loss rate and throughput;
on the basis of measured actual level of independence, maintain a rank list of combinations of pairs of the radio access networks 130 with respect to the level of redundancy that they provide; and
order adjustments to the configuration CONF of the traffic controller 113 according to the actual level of independence of the radio access networks 130.

The fifth and sixth items (measure, maintain) may be carried out by the processor 111 or in cooperation with the processor 111.

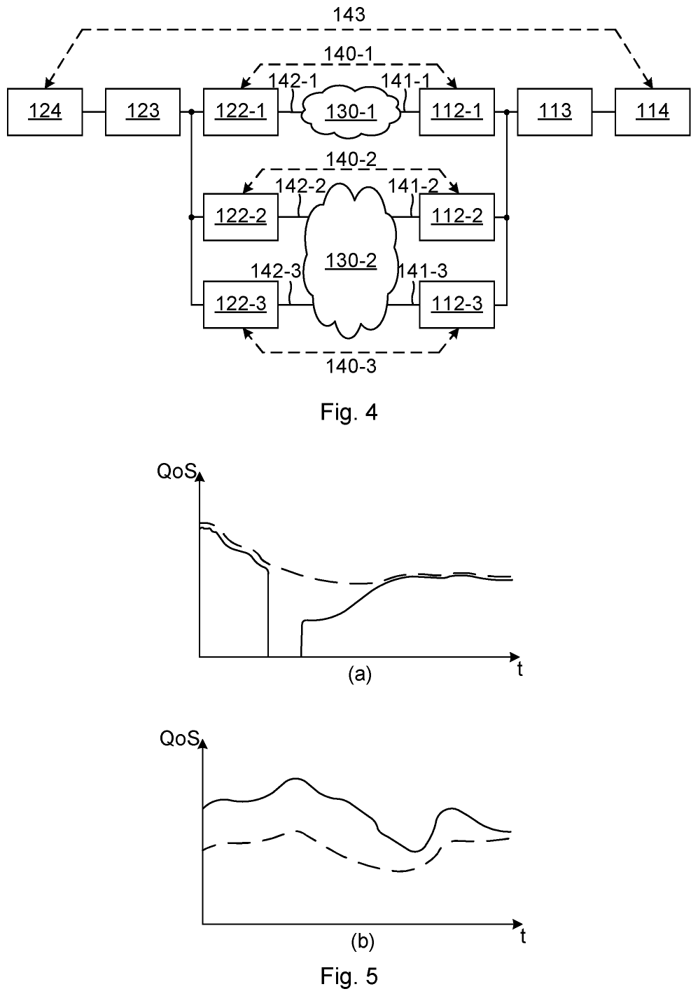

FIG. 5 illustrates a process by which the network supervisors 116 may perform or contribute to the performance of the four last items. This is to determine a level of independence between the contemporaneous physical connections 140 on the basis of measurements. To this effect, the network supervisors 116 carry out an evaluation process in which they monitor and compare pairs of time series for QoS-related quantities for the contemporaneous physical connections 140 in order to determine the level of mutual independence of the respective radio access networks 130. Multiple network supervisors 116 may collaborate to carry out the evaluation process; for example, individual network supervisors 116-k may provide a time series of a chosen QoS-related quantity for their associated radio access networks 130-k, and the comparison of the plural time series is made in one of the network supervisors 116k. Alternatively, the comparison is made by the processor 111 which receives the time series from the network supervisors 116-k. Further alternatively, the comparison is made by the traffic controller 113 which receives the time series from the network supervisors 116-k via the processor 111.

FIG. 5a is a plot of a QoS-related quantity as a function of time for two different physical connections, respectively drawn in solid and dashed line. The QoS-related quantity may for example be latency, reliability, throughput, jitter, packet loss or a standardized QoS measure. Throughput may be understood as the quantity of payload data exchanged per unit time. Over the plotted time interval, the physical connection drawn by solid line suffers a temporary outage followed by a recovery period with reduced QoS. Outside the outage and recovery period, the two QoS time series appear to be approximately equal. The common variations may be due to atmospheric factors or to factors (e.g., multipath propagation or fading) that vary with the automation device's 120 movements in space in the course of its normal operation.

A possible conclusion to be drawn from the QoS data plotted in FIG. 5a is that the two physical connections do not have an apparent single point of failure, and therefore their combination provides a satisfactory level of independence. The decision-making as to whether the level of independence is sufficient can be systematized (or automated) by computing a cross-correlation, a coherence or a cross-covariance between the time series, and then subjecting the resulting value to a predefined criterion; for instance, one may impose a criterion that the (normalized) cross-correlation must not exceed a threshold. If this is the case, it may be necessary to have the traffic controller 113 change the routing plan and/or increase the number of traffic flow replications. These actions may be ordered, or ordered indirectly, by modifying the configuration data CONF which is fed to the traffic controller 113. As mentioned above, the traffic controller 113 may be responsible for determining and maintaining a routing plan.

FIG. 5b is a plot of a QoS-related quantity as a function of time for another pair of physical connections. The appearance of the two time series plotted in FIG. 5b suggests a stronger mutual correlation. Although the offset between the time series appears to be decreasing gradually towards the end of the interval, the short-term variations are visibly similar. To reach better certainty regarding the level of independence afforded by the combination of these physical connections, it may be preferable to extend the time interval so that it also captures an outage episode. It is of particular interest to determine whether both physical connections are affected by the outage, or just one. If it turns out that the outage affects both of the physical connections, this supports a hypothesis that the level of independence is insufficient. A possible remedy is to replace one of the physical connections.

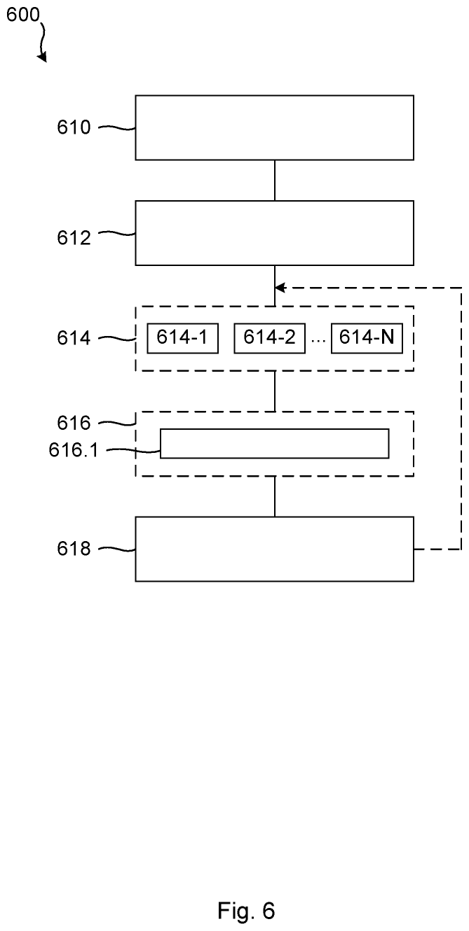

With reference to FIG. 6, a method 600 of establishing a logical connection 143 with physical redundancy between a control network 110 and an industrial automation device 120 will now be described. It is assumed that the automation device 120 operates in radio coverage of at least one radio access network 130-1, 130-2, . . . , 130-M. The method 600 may be carried out by a control network with the same general characteristics as the control network 110 described above with reference to FIGS. 1-4. More precisely, the method 600 may be carried out by the control network's 110 processor 111, traffic controller 113, network supervisors 116 or by combinations of these entities.

In a first step 610 of the method 600, at least two physical connections 140-1, 140-2, . . . , 140-N between the control network and the automation device are established.

In a second step 612, a logical connection 143 is established using at least one higher-layer communication protocol. In a 3GPP cellular network, the logical connection may be set up on the RRC layer or a higher layer. The logical connection 143 may be established in the application layer according to the OSI model. For example, the logical connection 143 may include a connection with a PROFINET™ master and a PROFINET™ slave instance as its endpoints, said endpoint being located in the control network 110 and an automation device 120.

In an optional third step 614, a time series of at least one of the following is monitored: quality of service, latency, reliability, throughput, jitter, packet loss. As suggested in FIG. 6, the monitoring for the N physical connections 140-1, 140-2, . . . , 140-N may be carried out in parallel.

In an optional fourth step 616, a level of independence between the contemporaneous physical connections 140-1, 140-2, . . . , 140-N is determined on the basis of the monitored time series, which constitute measurements. Further optionally, the fourth step 616 includes a substep 616.1 in which the time series for the at least two contemporaneous connections are compared.

In a fifth step 618 of the method, the physical redundancy of the logical connection 143 is repeatedly adapted. These adaptations of the physical redundancy may be periodical, event-triggered, or quasi-continuous, as explained above.

The execution flow of the method 600 goes on to repeating the fifth step 618, optionally together with the third 614 and/or fourth 616 steps. The execution may continue for as long as the automation device 120 is in active use.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A control network for supporting multiple industrial automation devices which operate in radio coverage of at least one radio access network, the control network comprising:
a processor configured to execute one or more software applications;
at least two wireless network interfaces, each configured to communicate with said automation devices; and
a traffic controller configured to provide a logical connection from an executing software application to one of the automation devices by maintaining at least two contemporaneous physical connections to said one of the automation devices using respective wireless network interfaces and said at least one radio access network,
wherein the control network is further configured to repeatedly adapt a physical redundancy of the logical connection.

2. The control network of claim 1, which is configured to determine a level of independence between the contemporaneous physical connections on the basis of measurements, and to adapt the physical redundancy accordingly.

3. The control network of claim 2, which is configured to:
monitor, for at least two of the contemporaneous physical connections, a time series of at least one of the following: quality of service, latency, reliability, throughput, jitter, packet loss; and
determine the level of independence by comparing the respective time series.

4. The control network of claim 3, which is configured to determine the level of independence by computing a cross-correlation, a coherence or a cross-covariance between the time series.

5. The control network of claim 2, wherein the processor is responsible for determining the level of independence between the contemporaneous physical connections and to order the traffic controller to adapt the physical redundancy.

6. The control network of claim 1, which is adapted for supporting automation devices operating in radio coverage of at least one radio access network, wherein at least two of the contemporaneous physical connections use different cells of the cellular radio access network.

7. The control network of claim 1, which is adapted for supporting automation devices operating in radio coverage of at least two radio access networks, wherein at least two of the contemporaneous physical connections use different radio access networks.

8. The control network of claim 1, wherein the processor is configured to:
define a setpoint redundancy level for each executing application;
determine configuration data (CONF) in accordance with the setpoint redundancy level; and
feed the configuration data to the traffic controller.

9. The control network of claim 8, wherein the traffic controller is configured to determine a routing plan on the basis of the configuration data (CONF).

10. The control network of claim 1, wherein the traffic controller is configured to apply frame replication and elimination for reliability, FRER, and/or IP tunneling in respect of selected ones of the executing software applications.

11. The control network of claim 1, wherein the traffic controller includes a managed network switch, such as a time-sensitive networking, TSN, switch.

12. The control network of claim 1, which is an automation backbone.

13. A traffic controller for use in a control network supporting multiple industrial automation devices which operate in radio coverage of at least one radio access network,
wherein the traffic controller has at its disposal at least two wireless network inter-faces and is configured to provide a logical connection from a software application, which executes in the control network, to one of the automation devices by maintaining at least two contemporaneous physical connections to said one of the automation devices using the wireless network interfaces.

14. A method of establishing a logical connection with physical redundancy between a control network and an industrial automation device operating in radio coverage of at least one radio access network, the method comprising:
establishing at least two physical connections between the control network and the automation device;
establishing the logical connection using a higher-layer communication protocol; and
repeatedly adapting a physical redundancy of the logical connection.

15. The method of claim 14, further comprising determining a level of independence between the contemporaneous physical connections on the basis of measurements,
wherein said adapting is performed on the basis of the determined level of independence.

16. The method of claim 15, further comprising monitoring a time series of at least one of the following: quality of service, latency, reliability, throughput, jitter, packet loss,
wherein said determining the level of independence includes comparing the time series for the at least two contemporaneous connections.

17. The control network of claim 2, which is adapted for supporting automation devices operating in radio coverage of at least one radio access network, wherein at least two of the contemporaneous physical connections use different cells of the cellular radio access network.

18. The control network of claim 2, which is adapted for supporting automation devices operating in radio coverage of at least two radio access networks, wherein at least two of the contemporaneous physical connections use different radio access networks.

19. The control network of claim 2, wherein the processor is configured to:
define a setpoint redundancy level for each executing application;
determine configuration data (CONF) in accordance with the setpoint redundancy level; and
feed the configuration data to the traffic controller.

20. The control network of claim 3, wherein the processor is responsible for determining the level of independence between the contemporaneous physical connections and to order the traffic controller to adapt the physical redundancy.
